(19) United States
(12) Patent Application Publication
(10) Pub. No.: US 2025/0111393 A1
(43) Pub. Date: Apr. 3, 2025

(54) RETURN AREA PREDICTION DEVICE

(71) Applicant: NTT DOCOMO, INC., Tokyo (JP)

(72) Inventors: Yusuke NAKAMURA, Chiyoda-ku (JP); Takashi SUZUKI, Chiyoda-ku (JP); Akira YAMADA, Chiyoda-ku (JP)

(73) Assignee: NTT DOCOMO, INC., Tokyo (JP)

(21) Appl. No.: 18/730,027

(22) PCT Filed: Feb. 8, 2023
(86) PCT No.: PCT/JP2023/004237

§ 371 Date: Jul. 18, 2024

(30) Foreign Application Priority Data
Apr. 4, 2022 (JP) 2022-062273

(51) Int. Cl. G06Q 30/0202

(52) U.S. Cl. CPC G06Q 30/0202

(57) ABSTRACT

A return area prediction device (10) includes a prediction unit (12) that acquires a regression result of prediction of a number of visitors in each return area for a target event from event information of the target event using a regularized regression method, specifies, based on the acquired regression result, a nearest-neighbor cluster closest to the regression result among event group clusters previously clustered, and predicts the number of visitors in each return area for the target event based on at least a position of a center of gravity of the nearest-neighbor cluster.

### TECHNICAL FIELD

The present disclosure relates to a return area prediction device that predicts a return area of visitors to various events, functions, performances, and the like (hereinafter, collectively referred to as “event”). The term “return area” used herein means an initial stay area in movement of a visitor immediately after an event. For example, in a case where a visitor has gone straight home immediately after an event, an area around the home is a return area, and in a case where a visitor has stopped at a commercial facility immediately after an event, an area around the commercial facility is a return area. A “traffic route” involved in prediction of a return area includes all sorts of routes such as railway routes and bus routes which are operated to allow stopping at predetermined stops along a predetermined route.

### BACKGROUND ART

In planning to hold various events, for the purpose of examination of measures of traffic improvement to an event venue, article sales marketing, or the like, it is important to predict in advance a return area of a visitor expected to visit an event. Incidentally, in the related art, an analysis result obtained by ascertaining and analyzing attribute information of a visitor of an event carried out in the past from ticket sales data or the like of the event or know-how of an event promoter is utilized as an alternative of return area information regarding a visitor of an event scheduled to be held to perform the examination of measures of traffic improvement to the event venue, article sales marketing, or the like. Patent Literature 1 discloses a technique that obtains an increased proportion in a number of people who alight at a nearest station before the start of an event on the day of the event compared to a number of people who have alighted from the same station on a day that the event has not been held, and predicts a number of people who will use the nearest station immediately after the end of the event, or the like based on the obtained proportion and the like.

### CITATION LIST

### Patent Literature

[Patent Literature 1] Japanese Unexamined Patent Publication No. 2015-219673

### SUMMARY OF INVENTION

### Technical Problem

Note that, even if the analysis result obtained based on the attribute information of the visitors to the past event, know-how of the event promoter, or the like is utilized and even if a number of users of the nearest station immediately after the end of the event is predicted based only on the number of people who alight at the nearest station before the start of the event on the day of the event, there is a limit to improving the prediction accuracy of the return area regarding visitors to the event scheduled to be held. In particular, there is a difficulty in application to prediction for a new event or a new event venue. The number of event performances itself is far behind a number of pieces of data required for general machine learning. For this reason, in a case where a machine learning method is applied as it is, too faithful alignment with a small amount of training data is made, resulting in overtraining that deviates from an original data trend, and an improvement in prediction accuracy of the return area may be prevented.

The present disclosure has been accomplished to solve the above-described problem, and an object of the present disclosure is to improve prediction accuracy of a return area regarding a visitor of an event scheduled to be held.

### Solution to Problem

A return area prediction device according to the present disclosure includes a prediction unit configured to acquire a regression result of prediction of a number of visitors in each return area for a target event from event information of the target event using a regularized regression method, specify, based on the acquired regression result, a nearest-neighbor cluster closest to the regression result among event group clusters previously clustered, and predict the number of visitors in each return area for the target event based on at least a position of a center of gravity of the nearest-neighbor cluster.

In the above-described return area prediction device, the prediction unit acquires the regression result of prediction of the number of visitors in each return area for the target event from the event information of the target event using the regularized regression method and specifies, based on the acquired regression result, the nearest-neighbor cluster closest to the regression result among the event group clusters previously clustered. Then, the prediction unit predicts the number of visitors in each return area for the target event based on at least the position of the center of gravity of the specified nearest-neighbor cluster. In this way, the nearest-neighbor cluster closest to the regression result according to the regularized regression method is specified, and the number of visitors in each return area for the target event is predicted based on at least the position of the center of gravity of the nearest-neighbor cluster. With this, for example, for an event that has not been held in the past or has been rarely held, even when tickets are not on sale, it is possible to predict the number of visitors in each return area for the target event with excellent accuracy.

The prediction unit has at least the position of the center of gravity of the nearest-neighbor cluster as basic information in predicting the number of visitors in each return area for the target event. As the basic information in this case, the regression result may be further used in addition to the position of the center of gravity of the nearest-neighbor cluster, but the use of the regression result alone is avoided. With this, it is possible to prevent overtraining that deviates from the original data trend, due to too faithful alignment with the regression result obtained by regression from the event information of the target event, and to avoid a situation in which the improvement in prediction accuracy of the return area is prevented.

### Advantageous Effects of Invention

According to the present disclosure, it is possible to improve prediction accuracy of a return area for a visitor to an event scheduled to be held.

### BRIEF DESCRIPTION OF DRAWINGS

FIG. 1 is a functional block configuration diagram of a return area prediction device according to an embodiment of the invention and related devices.

FIG. 2 is a diagram illustrating an example of location information that is collected by location information collection processing.

FIG. 3 is a diagram illustrating an example of event information regarding a past event group initially acquired by prediction model training processing.

FIG. 4 is a diagram illustrating an example of information of event visitors specified in the prediction model training processing.

FIG. 5(a) is a diagram illustrating an example (in units of cities, wards, towns, and villages) of statistical visitor information that is used for prediction model generation, FIG. 5(b) is a diagram illustrating an example (in units of stations) of statistical visitor information that is used for prediction model generation, FIG. 5(c) is a diagram illustrating an example (a visitor from a distant place) of statistical visitor information that is used for prediction model generation, and FIG. 5(d) is a diagram illustrating an example (location information aggregate result before event start) of statistical visitor information that is used for prediction model generation.

FIG. 6(a) is a diagram illustrating an example of event information of a target event initially acquired by return area prediction processing, and FIG. 6(b) is a diagram illustrating an example of location information aggregate data before event start acquired along with the event information as an option.

FIG. 7(a) is a diagram illustrating an example of a return area prediction result (in units of cities, wards, towns, and villages) output by the return area prediction processing, FIG. 7(b) is a diagram illustrating an example of a return area prediction result (in units of stations) output by the return area prediction processing, and FIG. 7(c) is a diagram illustrating an example of a return area prediction result (a visitor from a distant place) output by the return area prediction processing.

FIG. 8(a) is a flowchart illustrating the location information collection processing, FIG. 8(b) is a flowchart illustrating the prediction model training processing, and FIG. 8(c) is a flowchart illustrating the return area prediction processing.

FIG. 9(a) is a diagram illustrating a plurality of event group clusters acquired by the prediction model training processing, FIG. 9(b) is a diagram illustrating processing of specifying a nearest-neighbor cluster, and FIG. 9(c) is a diagram illustrating processing of predicting the number of people represented by a position of the center of gravity of the nearest-neighbor cluster as the number of visitors in each return area for the target event.

FIG. 10(a) is a flowchart illustrating Modification Example 1 of the return area prediction processing, and FIG. 10(b) is a diagram illustrating a prediction method in Modification Example 1.

FIG. 11(a) is a flowchart illustrating Modification Example 2 of the return area prediction processing, and FIG. 11(b) is a diagram illustrating a prediction method in Modification Example 2.

FIG. 12 is a diagram illustrating a hardware configuration example of the return area prediction device.

### DESCRIPTION OF EMBODIMENTS

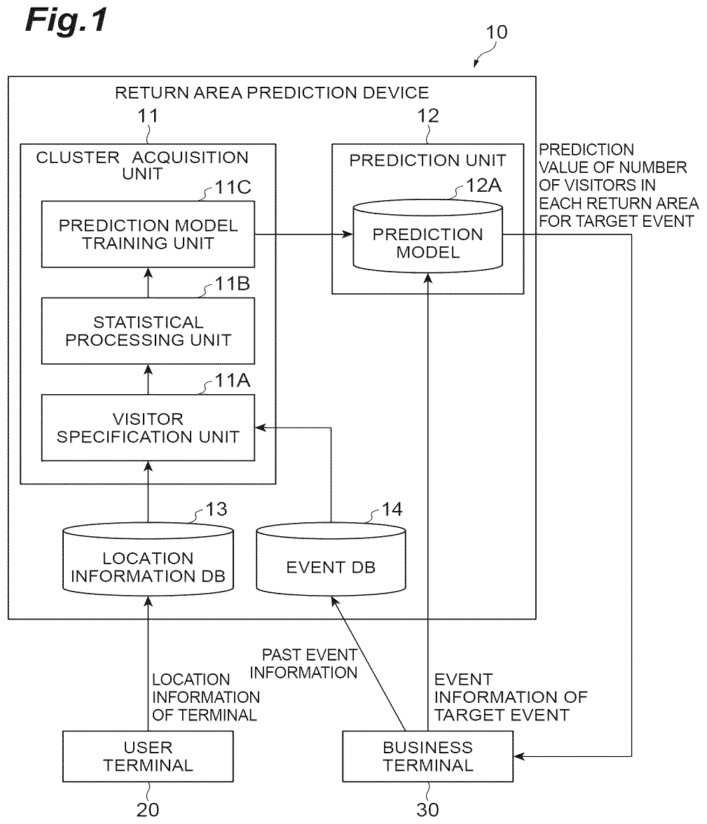

Hereinafter, an embodiment of a return area prediction device according to the present disclosure will be described referring to the drawings. As illustrated in FIG. 1, a return area prediction device 10 includes a cluster acquisition unit 11, a prediction unit 12, a location information database (DB) 13, and an event database (DB) 14. Hereinafter, the function of each unit will be schematically described.

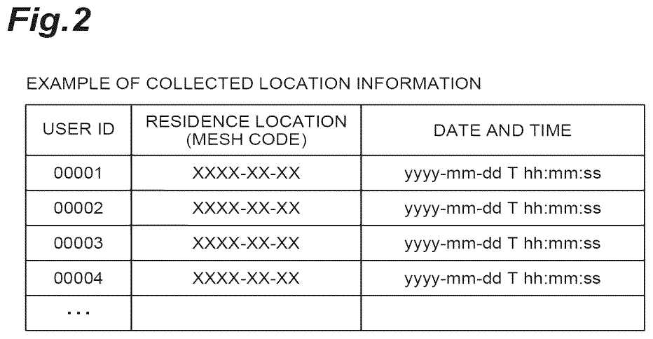

The location information DB 13 is a database that receives (collects) location information from various user terminals 20 at any time and stores the location information. For example, as illustrated in FIG. 2, the location information includes a residence location (a mesh code for identifying a mesh in which the user terminal resides) and information acquisition date and time, which are stored in the location information DB 13 along with an identifier (user ID) of a user.

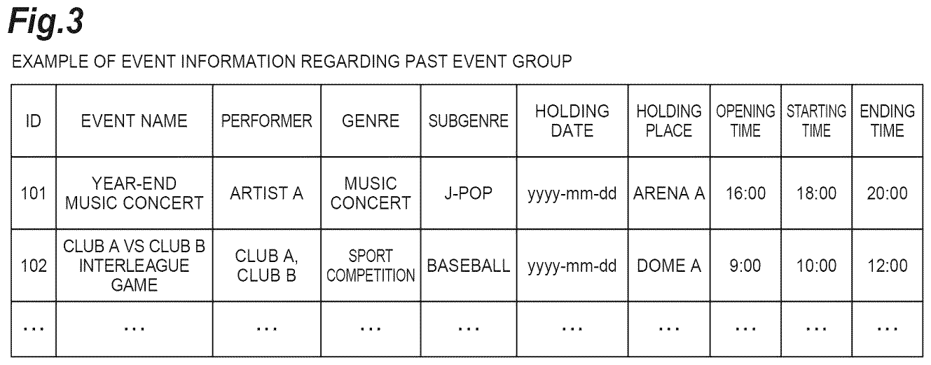

The event DB 14 is a database that receives (collects) event information regarding various past event groups from a business terminal 30 at any time and stores the event information. For example, as illustrated in FIG. 3, the event information includes an event name, a performer, a genre, a subgenre, a holding date, a holding place, an opening time, a starting time, and an ending time, which are stored in the event DB 14 along with an identifier (ID) of an event. The business terminal 30 is a terminal that relates to collection and management work of the event information, and is configured to input event information of a target event to the prediction unit 12, and acquire and output (display, output, or the like) a prediction value of a number of visitors in each return area for the target event output from the prediction unit 12. Note that the latter processing (the input of the event information of the target event or the acquisition and output of the prediction value of the number of visitors in each return area) may be executed by a terminal different from the business terminal 30.

The location information DB 13 and the event DB 14 are not always provided inside the return area prediction device 10, and may be provided in an external server or the like, and the return area prediction device 10 may acquire necessary information from the external server or the like.

The cluster acquisition unit 11 is a functional unit that obtains a number of visitors in each return area for each event based on movement history information of visitors in a past event group and clusters a plurality of events having close characteristics regarding the number of visitors in each return area to acquire event group clusters. The cluster acquisition unit 11 includes a visitor specification unit 11A, a statistical processing unit 11B, and a prediction model training unit 11C.

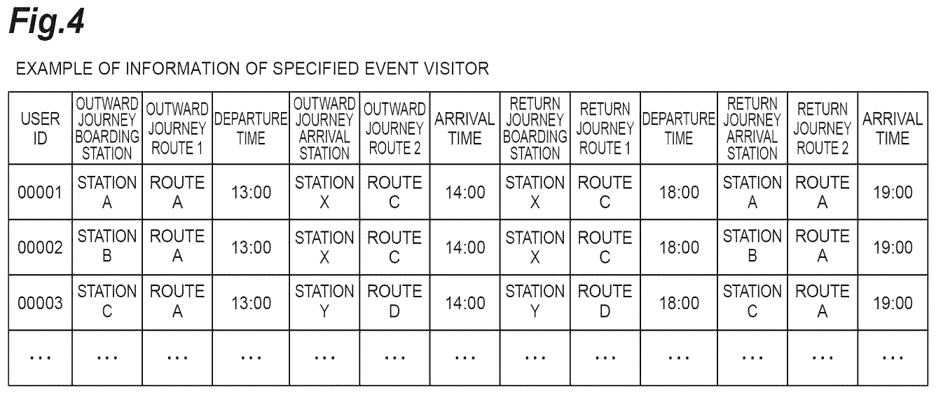

Of these, the visitor specification unit 11A acquires event information regarding the past event group from the event DB 14 and specifies visitors to an event according to the acquired event information based on the location information stored in the location information DB 13. For example, a user whose residence location (a mesh code in FIG. 2) in a time period between a starting time and an ending time on a holding date of a certain event is a mesh including a venue of the event is specified as a visitor to the event. As illustrated in FIG. 4, as an example of information of the specified event visitors, information (boarding station, routes 1 and 2, departure time, arrival station, and arrival time) regarding an outward journey and information (boarding station, routes 1 and 2, departure time, arrival station, and arrival time) regarding a return journey are acquired with a user ID for identifying each event visitor as a key.

The statistical processing unit 11B obtains a return area of each visitor after the event from a movement history of each visitor on the day of the event obtained based on the location information of the visitor specified by the visitor specification unit 11A, and acquires, as “statistical visitor information”, statistical information of the number of return area people obtained by statistically processing the number of visitors in each return area and visitor movement history aggregate information before the start of the event on the day of the event. As described above, since the “return area” is defined as an initial stay area in the movement of the visitor immediately after the event, the statistical processing unit 11B specifies an initial stay area (for example, an area where the visitor stays for a predetermined reference time or more) in the movement immediately after the event from the movement history of each visitor on the day of the event, and obtains the specified stay area as a return area.

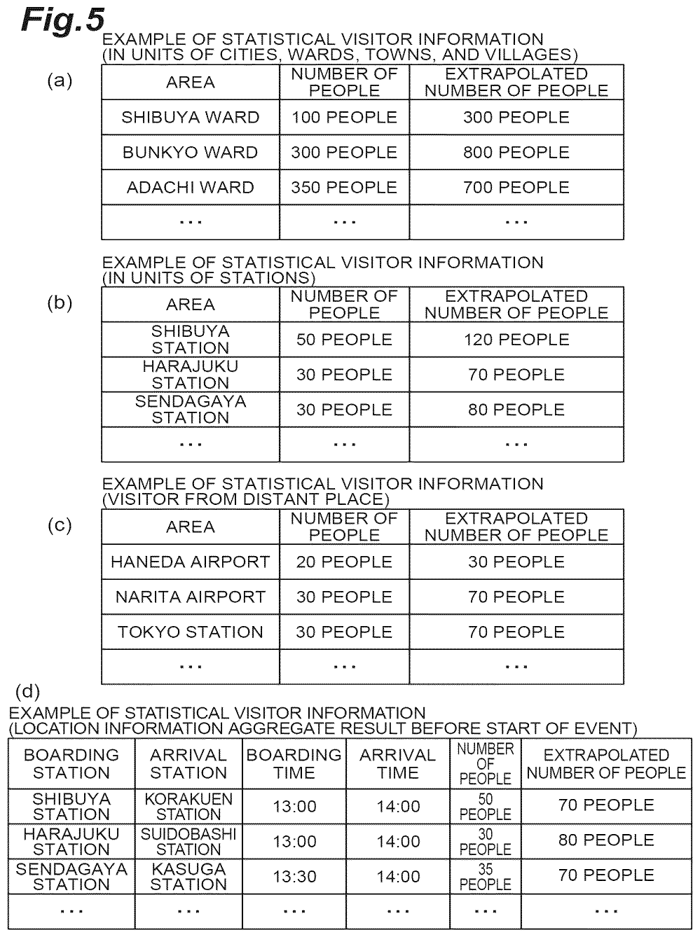

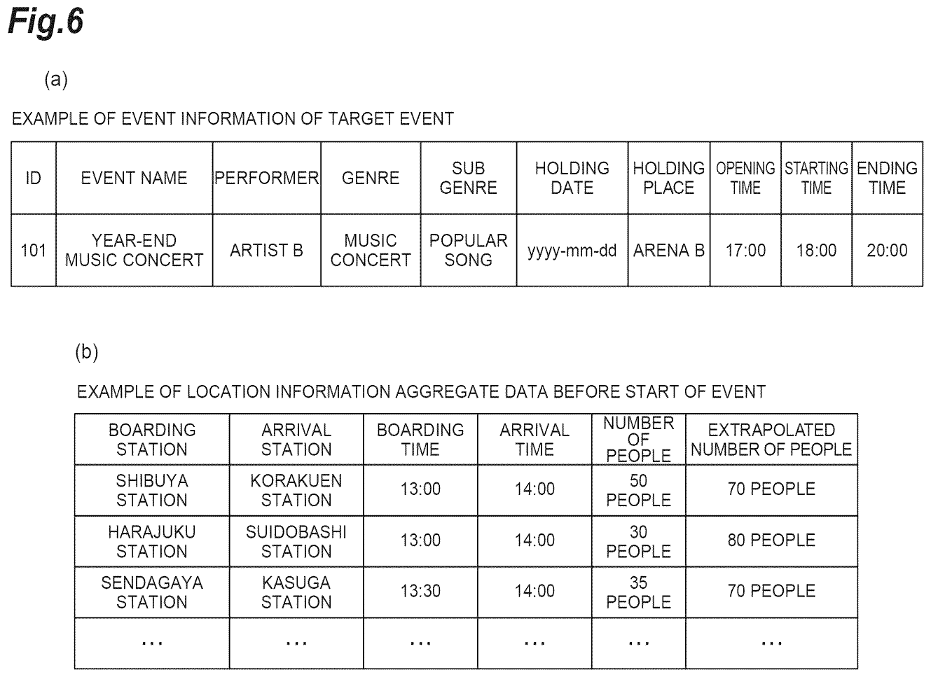

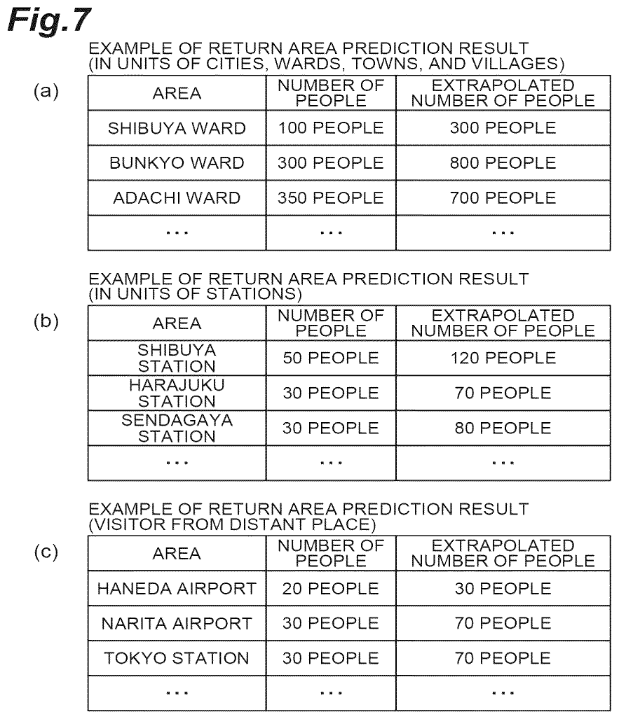

Examples of the “statistical information of the number of return area people” in the acquired statistical visitor information include statistical information of the number of return area people in units of cities, wards, towns, and villages illustrated in FIG. 5(a), statistical information of the number of return area people in units of stations illustrated in FIG. 5(b), and statistical information of the number of return area people regarding a visitor from a distant place illustrated in FIG. 5(c). Of these, in regard to “the visitor from the distant place”, the number of people illustrated in FIG. 5(c) is obtained by specifying visitors having a candidate facility (for example, Haneda Airport, Narita Airport, or Tokyo station illustrated in FIG. 5(c)) where a visitor from a distant place is expected to stay in the middle of a homeward journey, as a return area and counting the number of visitors in each candidate facility. On the other hand, an example of the “visitor movement history aggregate information before the start of the event on the day of the event” in the acquired statistical visitor information is aggregate information including a boarding station, an arrival station, a boarding time, an arrival time, the number of people, and the extrapolated number of people illustrated in FIG. 5(d). Of the examples of information illustrated in FIGS. 5(a) to 5(d), the “extrapolated number of people” means “the number of people in the whole communication industry” obtained by estimation based on “the number of people” that is able to be ascertained by a certain communication company and the share of the communication company in the communication industry. The “extrapolated number of people” in information illustrated in FIGS. 6(b) and 7(a) to 7(c) also has the same meaning.

The prediction model training unit 11C generates a prediction model that has, as an input, the visitor movement history aggregate information in the statistical visitor information acquired by the statistical processing unit 11B and the event information acquired by the visitor specification unit 11A and has, as an output, the statistical information of the number of return area people in the statistical visitor information, and clusters a plurality of events having close characteristics regarding the number of visitors in each return area for each event in the prediction model using a prescribed clustering method (Ward method or the like) to acquire event group clusters. The generated prediction model is transferred to the prediction unit 12 and is stored in the prediction unit 12. The prediction model training unit 11C updates a prediction model 12A stored in the prediction unit 12 each time training is subsequently performed and performs brush-up.

Next, the prediction unit 12 is a functional unit that acquires a regression result of prediction of a number of visitors in each return area for the target event from the event information of the target event input from the business terminal 30 using a regularized regression method (for example, Ridge regression or Lasso regression) while referring to the prediction model 12A, specifies, based on the acquired regression result, a nearest-neighbor cluster closest to the regression result among the event group clusters clustered and acquired by the cluster acquisition unit 11, predicts the number of visitors in each return area for the target event based on at least the position of the center of gravity of the nearest-neighbor cluster using various methods described below, and outputs a prediction value to the business terminal 30. In specifying the nearest-neighbor cluster, for example, the prediction unit 12 specifies, as the nearest-neighbor cluster, an event group cluster having the position of the center of gravity closest to a position indicated by the regression result of prediction of the number of visitors in each return area for the target event.

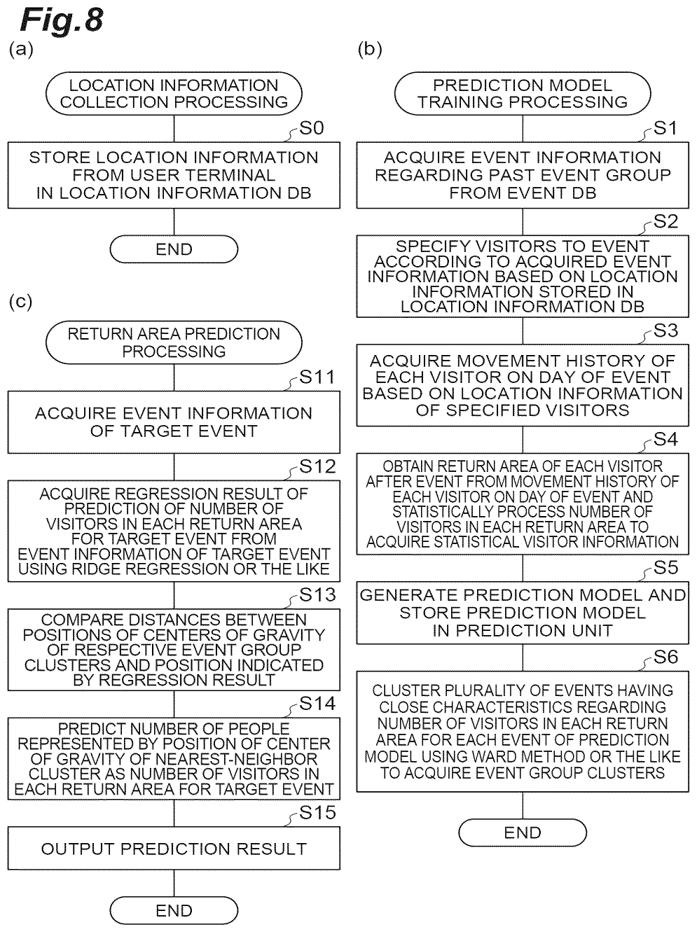

Next, processing that is executed in the return area prediction device 10 will be described along flowcharts of FIGS. 8(a) to 8(c). In location information collection processing illustrated in FIG. 8(a), in the return area prediction device 10, the location information transmitted from the user terminal 20 is received at any time and stored in the location information DB 13 (Step S0). Though not illustrated, similarly, the past event information transmitted from the business terminal 30 is received by the event DB 14 at any time and stored.

Prediction model training processing illustrated in FIG. 8(b) starts to be executed, for example, with the update of past event information as a trigger. First, the visitor specification unit 11A acquires the event information regarding the past event group from the event DB (Step S1), and specifies the visitors to the event according to the acquired event information based on the location information stored in the location information DB (Step S2). The location information of the specified visitor is transferred to the statistical processing unit 11B, and the statistical processing unit 11B acquires the movement history of each visitor on the day of the event from the location information of the specified visitors (Step S3), obtains the return area of each visitor after the event from the movement history of each visitor on the day of the event, and statistically processes the number of visitors in each return area to acquire statistical visitor information (Step S4). The acquired statistical visitor information is transferred to the prediction model training unit 11C.

The prediction model training unit 11C generates the prediction model that has, as an input, the visitor movement history aggregate information in the acquired statistical visitor information and the event information acquired by the visitor specification unit 11A and has, as an output, the statistical information of the number of return area people in the statistical visitor information, and stores the prediction model as the prediction model 12A in the prediction unit 12 (Step S5). Also, the prediction model training unit 11C updates the prediction model 12A stored in the prediction unit 12 each time training is subsequently carried out and performs brush-up.

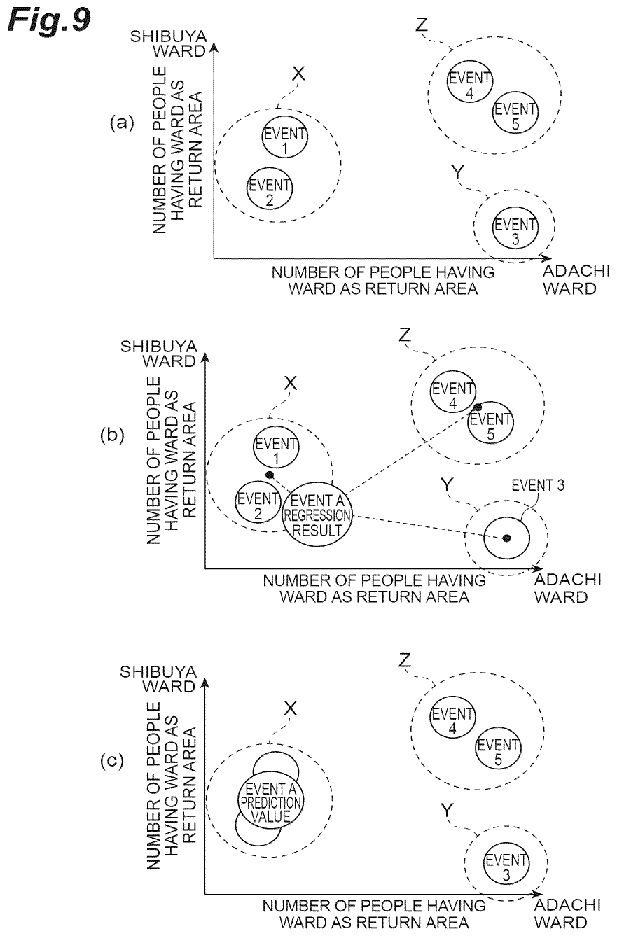

The prediction model training unit 11C clusters a plurality of events having close characteristics regarding the number of visitors in each return area for each event of the prediction model using a prescribed clustering method (Ward method or the like) to acquire event group clusters (Step S6). For example, as illustrated in FIG. 9(a), a cluster X including events 1 and 2, a cluster Y including an event 3, and a cluster Z including events 4 and 5 are acquired as event group clusters. FIG. 9(a) is a graph where information of the number of visitors in each return area for various events is displayed on two-dimensional coordinates including an axis of the number of visitors in a return area (Adachi Ward) and an axis of the number of visitors in a return area (Shibuya Ward) for convenience to facilitate understanding, and in practice, there are exes for cities, wards, towns, and villages of an analysis target. The same applies to graphs of FIGS. 9(b), 9(c), 10(b), and 11(b) described below.

Return area prediction processing illustrated in FIG. 8(c) starts to be executed, for example, with an input of an execution start instruction along with event information of a target event from the business terminal 30 by an operator as a trigger. Examples of the event information of the target event include information illustrated in FIGS. 6(a) and 6(b), a data format of FIG. 6(a) is similar to an example of past event information of FIG. 3 described above, and a data format of FIG. 6(b) is similar to an example of information of FIG. 5(d) described above.

First, the prediction unit 12 acquires event information of a target event from the business terminal 30 (Step S11), and acquires a regression result of prediction of the number of visitors in each return area for the target event from the event information of the target event using ridge regression or the like (Step S12). Then, the prediction unit 12 compares distances between the positions of the centers of gravity of the respective event group clusters and a position indicated by the regression result (Step S13). With the comparison, an event group cluster having a shortest distance is specified as a nearest-neighbor cluster. For example, as illustrated in FIG. 9(b), the distances between the positions of the centers of gravity of the respective event group clusters X, Y, and Z and a position indicated by a regression result of an event A are compared, and the event group cluster X having a shortest distance is specified as a nearest-neighbor cluster.

As an example of a prediction method, the prediction unit 12 predicts the number of people represented by the position of the center of gravity of the nearest-neighbor cluster as the number of visitors in each return area for the target event (Step S14), and outputs a prediction result to the business terminal 30 (Step S15). For example, as illustrated in FIG. 9(c), the number of people represented by the position of the center of gravity of the event group cluster X, which is the nearest-neighbor cluster, is a prediction value of the number of visitors in each return area for the target event (event A). Examples of the prediction value of the number of visitors in each return area for the target event (event A) include the return area prediction result in units of cities, wards, towns, and villages illustrated in FIG. 7(a), the return area prediction result in units of stations illustrated in FIG. 7(b), and the return area prediction result regarding the visitor from a distant place illustrated in FIG. 7(c). The “output” in Step S15 includes outputs in various forms such as display output on a display, print output to a printer, and data transmission to an external device.

The location information of the user terminal 20 used in the above-described embodiment is not limited to connection information of the user terminal 20 to a base station. GPS information of the user terminal 20, Wi-Fi (Registered Trademark) connection information of the user terminal 20, Bluetooth (Registered Trademark) beacon connection information, or the like may be used, and a similar result is obtained.

Hereinafter, the effects of the above-described embodiment will be described.

The prediction unit 12 predicts the number of visitors in each return area for the target event based on at least the position of the center of gravity of the specified nearest-neighbor cluster. In this way, the nearest-neighbor cluster closest to the regression result according to the regularized regression method is specified, and the number of visitors in each return area for the target event is predicted based on at least the position of the center of gravity of the nearest-neighbor cluster. With this, for example, for an event that has not been held in the past or has been rarely held, even when tickets are not on sale, it is possible to predict the number of visitors in each return area for the target event with excellent accuracy.

As an example of a prediction method, the prediction unit 12 predicts the number of people represented by the position of the center of gravity of the nearest-neighbor cluster as the number of visitors in each return area for the target event. In predicting the number of visitors in each return area for the target event in this way, the position of the center of gravity of the nearest-neighbor cluster is used as basic information. Note that, as the basic information in this case, as in Modification Examples 1 and 2 described below, the regression result according to the regularized regression method may be further used in addition to the position of the center of gravity of the nearest-neighbor cluster. However, the use of the regression result alone is avoided. With this, it is possible to prevent overtraining that deviates from the original data trend, due to too faithful alignment with the regression result obtained by regression from the event information of the target event, and to avoid a situation in which the improvement in prediction accuracy of the return area is prevented.

Through the processing illustrated in FIG. 8(b), the cluster acquisition unit 11 generates the prediction model that has, as an input, visitor movement history aggregate information in the statistical visitor information and the event information acquired by the visitor specification unit 11A and has, as an output, the statistical information of the number of return area people in the statistical visitor information, and clusters a plurality of events having close characteristics regarding the number of visitors in each return area for each event of the prediction model using a clustering method such as a Ward method to acquire the event group clusters. With the use of the method of generating the prediction model and clustering a plurality of event having close characteristics regarding the number of visitors in each return area for each event of the prediction model using a clustering method such as a Ward method in this way, it is possible to acquire the event group clusters in which the characteristics regarding the number of visitors in each return area for the past event are sufficiently reflected, and to contribute to improvement in the prediction accuracy of the return area.

### Modification Example 1 Regarding Prediction of a Number of Visitors in Each Return Area for Target Event

In the above-described embodiment, a simply implementable processing example where the prediction unit 12 predicts the number of people represented by the position of the center of gravity of the nearest-neighbor cluster as the number of visitors in each return area for the target event has been described. Note that this is just an example of a prediction method, and the following prediction methods (Modification Examples 1 and 2) other than the above-described prediction method may also be employed.

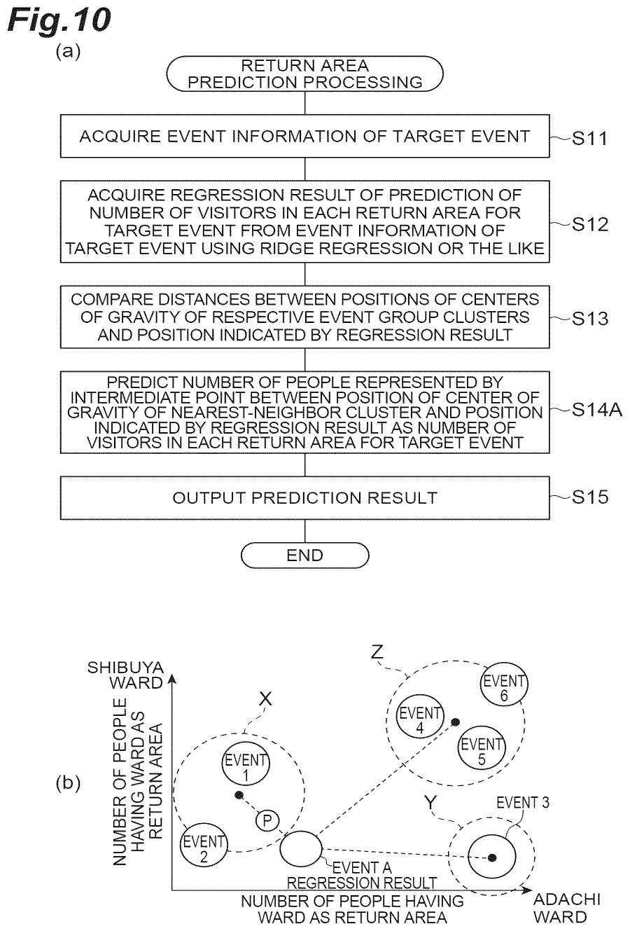

As Modification Example 1, the prediction unit 12 may predict the number of people represented by an intermediate point between the position of the center of gravity of the nearest-neighbor cluster and the position indicated by the regression result as the number of visitors in each return area for the target event. Specifically, in Step S14A of return area prediction processing illustrated in FIG. 10(a), the prediction unit 12 obtains the intermediate point between the position of the center of gravity of the nearest-neighbor cluster specified from the comparison result of Step S13 and the position indicated by the regression result, and predicts the number of people represented by the intermediate point as the number of visitors in each return area for the target event. Referring to a two-dimensional coordinate system illustrated in FIG. 10(b), distances between a regression result of a target event A and the positions of the centers of gravity of respective event group clusters X to Z are compared, since the distance from the event group cluster X is shortest, the event group cluster X is specified as a nearest-neighbor cluster, and the number of people represented by an intermediate point P between the position of the center of gravity of the nearest-neighbor cluster and the position indicated by the regression result is predicted as the number of visitors in each return area for the target event. In Modification Example 1, while the regression result is used as part of basic information for prediction, the intermediate point P between the position of the center of gravity of the nearest-neighbor cluster and the position indicated by the regression result is predicted as the number of visitors in each return area for the target event. Thus, it is possible to appropriately predict the number of visitors in each return area for the target event while suitably taking the regression result into consideration and preventing overtraining.

### Modification Example 2 Regarding a Number of Visitors in Each Return Area for Target Event

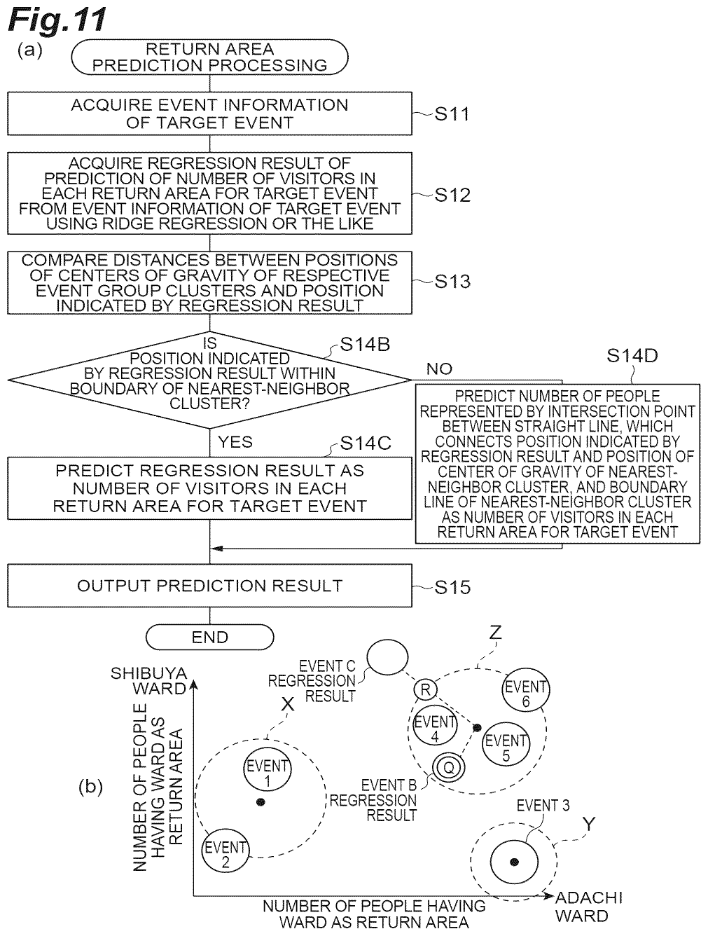

Next, Modification Example 2 will be described with reference to FIGS. 11(a) and 11(b). In Step S14B of return area prediction processing illustrated in FIG. 11(a), the prediction unit 12 determines whether or not the position indicated by the regression result is present within the boundary of the nearest-neighbor cluster specified from the comparison result of Step S13. Here, as indicated by “event B regression result” in FIG. 11(b), if a position Q indicated by a regression result of a target event B is present within the boundary of the nearest-neighbor cluster (in Step S14B, YES), the prediction unit 12 predicts the regression result as the number of visitors in each return area for the target event B (Step S14C).

On the other hand, in Step S14B, as indicated by “event C regression result” in FIG. 11(b), if a position indicated by a regression result of a target event C is not present within the boundary of the nearest-neighbor cluster (in Step S14B, NO), the prediction unit 12 predicts the number of people represented by an intersection point R between a straight line, which connects the position indicated by the regression result and the position of the center of gravity of the nearest-neighbor cluster (cluster Z), and a boundary line of the nearest-neighbor cluster (cluster Z) as the number of visitors in each return area for the target event (Step S14D).

In Modification Example 2, while the regression result is used as part of the basic information for prediction, in a case where the position indicated by the regression result of the target event is present within the boundary of the nearest-neighbor cluster, that is, the regression result is an appropriate value (is not so inappropriate as to cause overtraining), it is possible to predict the appropriate regression result as the number of visitors in each return area for the target event. On the other hand, in a case where the position indicated by the regression result of the target event is not present within the boundary of the nearest-neighbor cluster, the number of people represented by the intersection point R is predicted as the number of visitors in each return area for the target event, so that it is possible to prevent the prediction result from deviating to a region outside the nearest-neighbor cluster (cluster Z), and to prevent the prediction result from being so an inappropriate value as to cause overtraining.

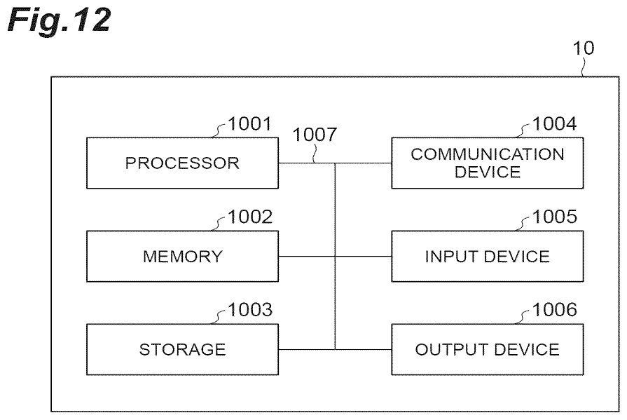

### (Description of Terms, Description of Hardware Configuration (FIG. 12), and the Like)

The block diagram used to describe the above-described embodiment and the modification examples illustrates blocks in units of functions. These functional blocks (constituent units) may be implemented in any combination of at least one of hardware and software. Also, the implementation method of each functional block is not particularly limited. That is, each functional block may be implemented using one device combined physically or logically or may be implemented by directly or indirectly connecting two or more devices separated physically or logically (for example, in a wired or wireless manner) and using the plurality of devices. The functional blocks may be implemented by combining software with one device or the plurality of devices.

The functions include determining, deciding, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like, but are not limited thereto. For example, a functional block (configuration unit) that causes transmitting is referred to as a transmitting unit or a transmitter. In any case, as described above, the implementation method is not particularly limited.

For example, the return area prediction device in an embodiment of the present disclosure may function as a computer that executes processing in the present embodiment. FIG. 12 is a diagram illustrating a hardware configuration example of the return area prediction device 10 according to the embodiment of the present disclosure. The above-described return area prediction device 10 may be physically configured as a computer apparatus including a processor 1001, a memory 1002, a storage 1003, a communication device 1004, an input device 1005, an output device 1006, a bus 1007, and the like.

In the following description, the term “apparatus” can be replaced with a circuit, a device, a unit, or the like. The hardware configuration of the return area prediction device 10 may be configured to include one or a plurality of devices among the devices illustrated in the drawing or may be configured without including part of the devices.

Each function in the return area prediction device 10 is implemented by having the processor 1001 perform an arithmetic operation by reading prescribed software (program) on hardware such as the processor 1001 and the memory 1002, and control communication by the communication device 1004 or at least one of reading and writing of data in the memory 1002 and the storage 1003.

The processor 1001 operates, for example, an operating system to control the entire computer. The processor 1001 may be configured with a central processing unit (CPU) including an interface with peripheral devices, a control device, an arithmetic device, a register, and the like.

The processor 1001 reads a program (program code), a software module, data, and the like from at least one of the storage 1003 and the communication device 1004 to the memory 1002 and executes various kinds of processing according to the program, the software module, data, and the like. As the program, a program that causes the computer to execute at least a part of the operations described in the above-described embodiment is used. Although the description has been made that various kinds of processing described above are executed by one processor 1001, various kinds of processing may be executed simultaneously or sequentially by two or more processors 1001. The processor 1001 may be implemented by one or more chips. The program may be transmitted from the network via a telecommunication line.

The memory 1002 is a computer-readable recording medium, and may be configured with at least one of, for example, a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store a program (program code), a software module, or the like that is executable to perform a wireless communication method according to an embodiment of the present invention.

The storage 1003 is a computer-readable recording medium, and may be configured with at least one of, for example, an optical disc such as a compact Disc ROM (CD-ROM), a hard disk drive, a flexible disk, a magneto-optical disk (for example, a compact disk, a digital versatile disk, or a Blu-ray (Registered Trademark) disk), a smart card, a flash memory (for example, a card, a stick, or a key drive), a Floppy (Registered Trademark) disk, and a magnetic strip. The storage 1003 may be referred to as an auxiliary storage device. The above-described storage medium may be, for example, a database including at least one of the memory 1002 and the storage 1003 or other appropriate mediums.

The communication device 1004 is hardware (transmission and reception device) that is provided to perform communication between computers via at least one of a wired network and a wireless network, and is also referred to as, for example, a network device, a network controller, a network card, or a communication module.

The input device 1005 is an input device (for example, a keyboard, a mouse, a microphone, a switch, a button, or a sensor) that receives an input from the outside. The output device 1006 is an output device (for example, a display, a speaker, or an LED lamp that performs an output to the outside. The input device 1005 and the output device 1006 may be integrated (for example, a touch panel). The devices such as the processor 1001 and the memory 1002 are connected by the bus 1007 that is provided to communicate information. The bus 1007 may be configured using a single bus or may be used using different buses between devices.

Each aspect/embodiment described in the present disclosure may be used alone, may be used in combination, or may be switched according to implementation. Furthermore, notification of predetermined information (for example, notification of “being X”) is not limited to explicit notification, but may be performed by implicit notification (for example, not performing notification of the predetermined information).

While the present disclosure has been described above in detail, it will be apparent to those skilled in the art that the present disclosure is not limited to the embodiments described in the present disclosure. The present disclosure may be implemented as modified and changed aspects without departing from the spirit and scope of the present disclosure defined by the description in the claims. Therefore, the description in the present disclosure is for illustration and does not have any restrictive meaning with respect to the present disclosure.

A process procedure, a sequence, a flowchart, and the like in each aspect/embodiment described in the present disclosure may be in a different order unless inconsistency arises. For example, for the method described in the present disclosure, elements of various steps are presented using an exemplary order, and the elements are not limited to the presented specific order.

Input or output information or the like may be stored in a specific place (for example, a memory) or may be managed using a management table. Information or the like to be input or output can be overwritten, updated, or additionally written. Output information or the like may be deleted. Input information or the like may be transmitted to another device.

The expression “based on” used in the present disclosure does not mean “based on only” unless otherwise described. In other words, the expression “based on” means both “based on only” and “based on at least”.

In the present disclosure, the terms “include”, “including”, and modifications thereof are used, these terms are intended to be comprehensive similarly to the term “comprising”. In addition, the term “or” used in the present disclosure is intended not to be an exclusive OR.

In the present disclosure, for example, in a case where an article such as “a”, “an”, or “the” in English is added through translation, the present disclosure may include a case where a noun following the article is of a plural form.

In the present disclosure, the term “A and B are different” may mean that “A and B are different from each other”. This term may mean that “each of A and B is different from C”. Terms “separate” and “coupled” may also be interpreted in a similar manner to “different”.

### REFERENCE SIGNS LIST

10: Return area prediction device, 11: Cluster acquisition unit, 11A: Visitor specification unit, 11B: Statistical processing unit, 11C: Prediction model training unit, 12: Prediction unit, 12A: Prediction model, 13: Location information DB, 14: Event DB, 20: User terminal, 30: Business terminal, 1001: Processor, 1002: Memory, 1003: Storage, 1004: Communication device, 1005: Input device, 1006: Output device, 1007: Bus

1. A return area prediction device comprising:
a prediction unit configured to acquire a regression result of prediction of a number of visitors in each return area for a target event from event information of the target event using a regularized regression method, specify, based on the acquired regression result, a nearest-neighbor cluster closest to the regression result among event group clusters previously clustered, and predict the number of visitors in each return area for the target event based on at least a position of a center of gravity of the nearest-neighbor cluster.

2. The return area prediction device according to claim 1, further comprising:
a cluster acquisition unit configured to obtain the number of visitors in each return area for each event based on movement history information of visitors in a past event group and cluster a plurality of events having close characteristics regarding the number of visitors in each return area to acquire the event group clusters.

3. The return area prediction device according to claim 2,
wherein the cluster acquisition unit includes
a visitor specification unit configured to acquire event information regarding a past event group and specify visitors to an event according to the acquired event information based on location information stored in a location information database storing location information of various users,
a statistical processing unit configured to obtain a return area of each visitor after the event from a movement history of each visitor on a day of the event obtained based on the location information of the visitors specified by the visitor specification unit and acquire, as statistical visitor information, statistical information of a number of return area people obtained by statistically processing the number of visitors in each return area and visitor movement history aggregate information before a start of the event on the day of the event, and
a prediction model training unit configured to generate a prediction model that has, as an input, the visitor movement history aggregate information in the statistical visitor information acquired by the statistical processing unit and the event information acquired by the visitor specification unit and has, as an output, the statistical information of the number of return area people in the statistical visitor information, and cluster a plurality of events having close characteristics regarding the number of visitors in each return area for each event for the prediction model using a prescribed clustering method to acquire the event group clusters.

4. The return area prediction device according to claim 1,
wherein the prediction unit is configured to
predict a number of people represented by the position of the center of gravity of the nearest-neighbor cluster as the number of visitors in each return area for the target event.

5. The return area prediction device according to claim 1,
wherein the prediction unit is configured to
predict a number of people represented by an intermediate point between the position of the center of gravity of the nearest-neighbor cluster and a position indicated by the regression result as the number of visitors in each return area for the target event.

6. The return area prediction device according to claim 1,
wherein the prediction unit is configured to
predict the regression result as the number of visitors in each return area for the target event in a case where a position indicated by the regression result is present within a boundary of the nearest-neighbor cluster, and
predict a number of people represented by an intersection point between a straight line, which connects the position indicated by the regression result and the position of the center of gravity of the nearest-neighbor cluster, and a boundary line of the nearest-neighbor cluster as the number of visitors in each return area for the target event in a case where the position indicated by the regression result is absent within the boundary of the nearest-neighbor cluster.

7. The return area prediction device according to claim 2,
wherein the prediction unit is configured to
predict a number of people represented by the position of the center of gravity of the nearest-neighbor cluster as the number of visitors in each return area for the target event.

8. The return area prediction device according to claim 2,
wherein the prediction unit is configured to
predict a number of people represented by an intermediate point between the position of the center of gravity of the nearest-neighbor cluster and a position indicated by the regression result as the number of visitors in each return area for the target event.

9. The return area prediction device according to claim 2,
wherein the prediction unit is configured to
predict the regression result as the number of visitors in each return area for the target event in a case where a position indicated by the regression result is present within a boundary of the nearest-neighbor cluster, and
predict a number of people represented by an intersection point between a straight line, which connects the position indicated by the regression result and the position of the center of gravity of the nearest-neighbor cluster, and a boundary line of the nearest-neighbor cluster as the number of visitors in each return area for the target event in a case where the position indicated by the regression result is absent within the boundary of the nearest-neighbor cluster.

10. The return area prediction device according to claim 3,
wherein the prediction unit is configured to
predict a number of people represented by the position of the center of gravity of the nearest-neighbor cluster as the number of visitors in each return area for the target event.

11. The return area prediction device according to claim 3,
wherein the prediction unit is configured to
predict a number of people represented by an intermediate point between the position of the center of gravity of the nearest-neighbor cluster and a position indicated by the regression result as the number of visitors in each return area for the target event.

12. The return area prediction device according to claim 3,
wherein the prediction unit is configured to
predict the regression result as the number of visitors in each return area for the target event in a case where a position indicated by the regression result is present within a boundary of the nearest-neighbor cluster, and
predict a number of people represented by an intersection point between a straight line, which connects the position indicated by the regression result and the position of the center of gravity of the nearest-neighbor cluster, and a boundary line of the nearest-neighbor cluster as the number of visitors in each return area for the target event in a case where the position indicated by the regression result is absent within the boundary of the nearest-neighbor cluster.
